(19) United States
(12) Patent Application Publication
(10) Pub. No.: US 2008/0079889 A1
(43) Pub. Date: Apr. 3, 2008

(54) DISPLAY APPARATUS AND METHOD OF FABRICATING THE SAME

(75) Inventors: Jin-Suk Lee, Yongin-si (KR); Hong-Tae Baeg, Hwaseong-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 11/866,667

(22) Filed: Oct. 3, 2007

(30) Foreign Application Priority Data
Oct. 3, 2006 (KR) 10-2006-0097466

(51) Int. Cl. G02F 1/1333; H01J 9/24

(52) U.S. Cl. 349/151; 445/24

(57) ABSTRACT

A display apparatus includes a display panel having a signal pad section that receives image signals and provides the image signals to a signal line, and a conductive bonding member that is interposed between the signal pad section and a driver. The conductive bonding member is cured by light incident through an opening in the signal pad section and the heat generated as the light is absorbed in the signal pad section. The temperature difference between the display panel and the driver is reduced, so that the display is prevented from being bent, and the yield of products and the productivity are improved.

This application claims priority to Korean Patent Application No. 2006-97466, filed on Oct. 3, 2006, and all the benefits accruing therefrom under 35 U.S.C. §119, the contents of which in its entirety are herein incorporated by reference.

### BACKGROUND OF THE INVENTION

1. Field of the Invention

The present invention relates to a display apparatus and a method of fabricating the same. More particularly, the present invention relates to a display apparatus capable of improving a yield of products and a method of fabricating the display apparatus.

2. Description of the Related Art

In general, a liquid crystal display (“LCD”) displays an image using liquid crystals having optical characteristics and electrical characteristics such as an anisotropic refractive index and an anisotropic dielectric constant. The LCD includes an LCD panel that substantially displays an image, and a backlight assembly that provides light to the LCD panel.

The LCD panel displays the image in response to data signals and gate signals that are provided from a data driver and a gate driver, respectively. The data driver is mounted on the LCD panel to receive the image signals from an outside and output the data signals. The data driver is prepared in a drive chip or a film, such as tape carrier package (“TCP”) or a flexible printed circuit board (“PCB”) having wires therein. Similar to the data driver, the gate driver is prepared in a drive chip or a film to be mounted on the LCD panel, or a circuit module constituting the gate driver is directly formed on the LCD panel. In a case in which the gate driver is directly formed on the LCD panel, the gate driver is substantially simultaneously formed when forming a thin film transistor (“TFT”) that controls the liquid crystals of the LCD panel.

The data driver and the gate driver that are provided in the form of a drive chip or a film are attached to the LCD panel using an anisotropic conductive film (“ACF”). In order to mount the data driver and the gate driver, the ACF is interposed between the LCD panel and the gate driver and between the LCD panel and the data driver, and then a heating device is disposed above the data driver and the gate driver. The heating device applies heat to the data driver while pressing the data driver, thereby curing the ACF. Thus, the data driver and the gate driver are fixed to the LCD panel.

### BRIEF SUMMARY OF THE INVENTION

When a heating device applies heat to cure the anisotropic conductive film (“ACF”), the data driver, the gate driver and the liquid crystal display (“LCD”) panel of a conventional device expand due to the heat applied thereto from the heating device, so that the data driver, the gate driver and the LCD panel are bent due to pressing force of the heating device and then are gradually contracted as the temperature falls down. However, since the heat generated from the heating device is transferred to the ACF and the LCD panel through the data driver and the gate driver, the temperature of the data driver and the data driver is lower than that of the LCD panel. Due to the temperature difference, the data driver, the gate driver and the LCD panel are contracted differently, thereby causing the LCD panel of the conventional device to be bent.

The present invention provides a display apparatus, capable of improving a yield of the products.

The present invention also provides a method of fabricating the display apparatus.

In exemplary embodiments of the present invention, a display apparatus includes a display panel, a driver and a conductive bonding member. The display panel includes at least one signal line transmitting image signals and a signal pad section which extends from an end portion of each of the at least one signal line to receive the image signals and a portion of which is removed to form at least one opening, to display images corresponding to the image signals received through the at least one signal line and the signal pad section. The driver is mounted on the display panel to output the image signals to the signal pad section. The conductive bonding member is interposed between the driver and the signal pad section to attach the driver to the display panel and to electrically connect the signal pad section with the driver.

The conductive bonding member may be cured by a light provided from below the driver, where the display panel is disposed between the light and the driver.

In other exemplary embodiments of the present invention, a display apparatus includes a display panel, a driver and a conductive bonding member.

The display panel displays an image in response to image signals. The driver includes a base film, at least one lead line and a lead pad section. The at least one lead line is formed at an upper surface of the base film to transmit the image signals. The lead pad section extends from an end portion of each of the at least one lead line to output the image signals to the display panel and a portion of the lead pad section is removed to form at least one opening. The conductive bonding member is interposed between the lead pad section and the display panel to attach the driver to the display panel and to electrically connect the lead pad section with the display panel.

The conductive bonding member may be cured by a light provided from above the base film, where the base film is disposed between the light and the display panel.

In still other exemplary embodiments of the present invention, a method of fabricating a display apparatus is provided as follows.

First, a display panel having a signal pad section which is formed with at least one opening and receives image signals is disposed. A conductive bonding member is attached to an upper portion of the signal pad section, and then a driver, which outputs the image signals, is disposed on an upper surface of the conductive bonding member. The light is irradiated onto the signal pad section from below the display panel while pressing the driver against the display panel to cure the conductive bonding member.

In yet still other exemplary embodiments of the present invention, a method of fabricating a display apparatus is provided as follows.

First, a display panel having a signal pad section which receives image signals and transmits the image signals to a signal line is disposed, and a conductive bonding member is attached to an upper portion of the signal pad section. A driver having a lead pad section, which is formed with at least one opening and outputs the image signals, is disposed on an upper surface of the conductive bonding member. The conductive bonding member is cured by irradiating light onto the lead pad section from above the driver while pressing the driver against the display panel.

According to the above, the openings are formed through the pad section formed at the upper surface or the lower surface of the conductive bonding member, so that the conductive bonding member is cured by the light incident through the opening and the heat generated from the pad section by the light. Thus, the temperature difference between the display panel and the driver is reduced, thereby preventing the display panel from being bent, and improving the yield and the productivity of products.

### BRIEF DESCRIPTION OF THE DRAWINGS

The above and other features and advantages of the present invention will become readily apparent by reference to the following detailed description when considered in conjunction with the accompanying drawings wherein:

FIG. 1 is a plan view showing an exemplary embodiment of a liquid crystal display (“LCD”) according to an embodiment of the present invention;

FIG. 2 is a sectional view taken along line I-I′ shown in FIG. 1;

FIG. 3 is a plan view representing an exemplary data line shown in FIG. 1;

FIGS. 4A and 4B are plan views representing other exemplary embodiments of the data pad section shown in FIG. 3;

FIG. 5 is a flowchart representing an exemplary embodiment of a method of fabricating the exemplary LCD according to the present invention;

FIG. 6 is a sectional view representing an exemplary process of curing a conductive bonding member shown in FIG. 2;

FIG. 7 is a plan view representing another exemplary embodiment of an LCD according to the present invention;

FIG. 8 is a sectional view taken along line II-II′ shown in FIG. 7;

FIG. 9 is a plan view representing an exemplary data tape carrier package (“TCP”) shown in FIG. 7;

FIG. 10 is a plan view representing an exemplary output lead line shown in FIG. 9;

FIGS. 11A and 11B are plan views representing other exemplary embodiments of the lead pad section shown in FIG. 10;

FIG. 12 is a flowchart illustrating another exemplary embodiment of a method of fabricating an exemplary LCD according to the present invention; and

FIG. 13 is a sectional view representing an exemplary process of curing the conductive bonding member shown in FIG. 7.

### DETAILED DESCRIPTION OF THE INVENTION

Hereinafter, exemplary embodiments of the present invention will be explained in detail with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the thickness of layers, films, and regions are exaggerated for clarity. Like numerals refer to like elements throughout.

It will be understood that when an element such as a layer, film, region, or substrate is referred to as being “on” another element, it can be directly on the other element or intervening elements may also be present. In contrast, when an element is referred to as being “directly on” another element, there are no intervening elements present. As used herein, the term “and/or” includes any and all combinations of one or more of the associated listed items. It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments of the present invention are described herein with reference to cross section illustrations that are schematic illustrations of idealized embodiments of the present invention. As such, variations from the shapes of the illustrations as a result, for example, of manufacturing techniques and/or tolerances, are to be expected. Thus, embodiments of the present invention should not be construed as limited to the particular shapes of regions illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the invention.

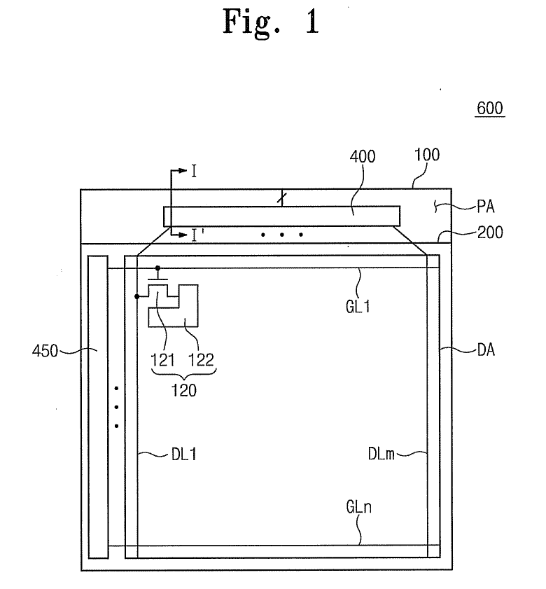

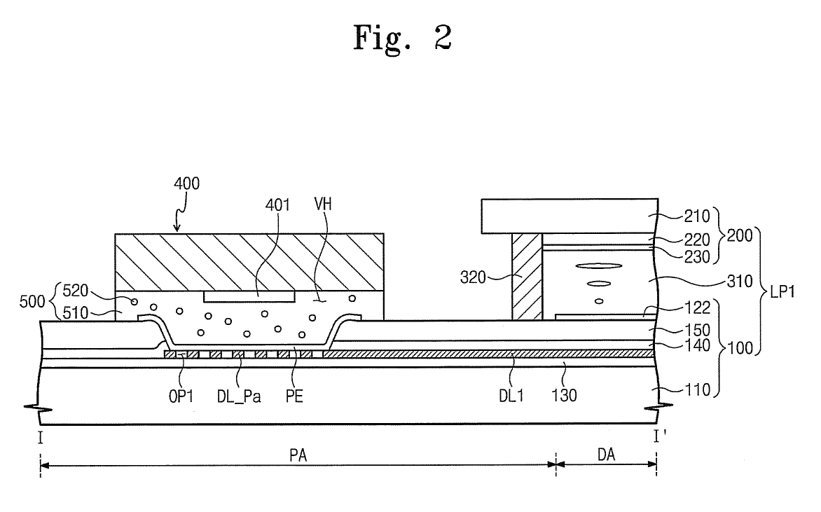

FIG. 1 is a plan view representing an exemplary embodiment of a liquid crystal display (“LCD”) according to the present invention, and FIG. 2 is a sectional view taken along a line I-I′ shown in FIG. 1.

Referring to FIGS. 1 and 2, the LCD 600 includes an LCD panel LP1 that displays an image, a data driver 400 that outputs data signals corresponding to the image, and a gate driver 450 that outputs gate signals corresponding to the image.

The LCD panel LP1 includes an array substrate 100, an opposite substrate 200, a liquid crystal layer 310, and a sealant 320. The array substrate 100 includes a first base substrate 110, a plurality of data lines DL1, . . . and DLm, a plurality of gate lines GL1, . . . and GLn, and a pixel unit 120.

The first base substrate 100 is divided into a display area DA on which the image is displayed, and a peripheral area PA surrounding the display area DA. The display area DA includes a plurality of pixel areas, and the image is not substantially displayed on the peripheral area PA.

The data lines DL1, . . . and DLm include first to m^{th} data lines DL1 to DLm, and are arranged on the first base substrate 110, (wherein, m is a natural number not less than 1). The first to m^{th} data lines DL1 to DLm receive the data signals from the data driver 400 and transfer the data signals to the pixel areas.

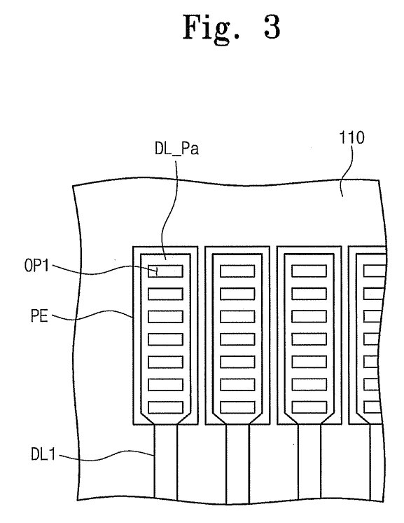

FIG. 3 is a plan view representing the exemplary data line shown in FIG. 1.

Referring to FIGS. 1 and 3, the first to m^{th} data lines DL1 to DLm include a conductive metal material such as aluminum, aluminum alloy, chromium, and molybdenum, and data pad sections DL_Pa extend from end portions of the first to m^{th} data lines DL1 to DLm. The data pad section DL_Pa is formed in the peripheral area PA to receive the data signals from the data driver 400, and has a width larger than that of each of the first to m^{th} data lines DL1 to DLm.

Referring to FIGS. 2 and 3, a portion or portions of the data pad section DL_Pa is removed to form an opening or a plurality of openings OP1 having a slit structure. As an example of the present invention, the openings OP1 are arranged in a longitudinal direction of the data pad section DL_Pa, substantially parallel to each other, and each opening OP1 extends in a width direction of the data pad section DL_Pa. When the openings OP1 are viewed in a plan view, the openings OP1 are arranged in parallel with respect to each other in the longitudinal direction of the data pad section DL_Pa. However, in an alternative exemplary embodiment, the opening OP1 may extend in the longitudinal direction of the data pad section DL_Pa, and the openings OP1 may be arranged substantially parallel with respect to each other in the width direction of the data pad section DL_Pa.

Although the present exemplary embodiment of the data pad section DL_Pa is illustrated as including seven openings OP1, the number of the openings OP1 may be changed according to the width, the material, and the process condition of the data pad section DL_Pa.

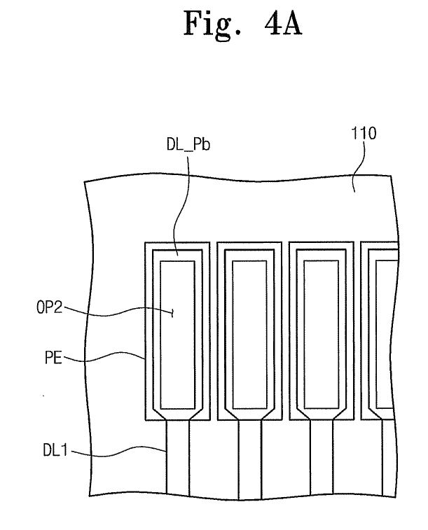

FIGS. 4A and 4B are plan views representing other exemplary embodiments of the data pad section shown in FIG. 3.

Referring to FIG. 4A, the middle portion of the data pad section DL_Pb is removed to form an opening OP2. The opening OP2 extends in the longitudinal direction of the data pad section DL_Pb.

Referring to FIG. 4B, a portion of the data pad section DL_Pc is removed to form an opening OP3 or a plurality of openings OP3 having a slit structure. The openings OP3 are arranged with respect to each other in the longitudinal direction of the data pad section DL_Pc, and each opening OP3 extends in the width direction of the data pad section DL_Pc. When the openings OP3 are viewed in a plan view, the openings OP3 are inclined with respect to the longitudinal direction of the data pad section DL_Pc.

Referring to FIGS. 1 and 2 again, the gate lines GL1 to GLn include first to n^{th} gate lines GL1 to GLn, and receive the gate signals from the gate driver 450 and then transfer the gate signals (wherein, n represents a natural number not less than 1). The first to n^{th} gate lines GL1 to GLn are insulated from the first to m^{th} data lines DL1 to DLm while crossing the first to m^{th} data lines DL1 to DLm, such as by the gate insulating layer 130, and the first to n^{th} gate lines GL1 to GLn include the conductive metal material such as aluminum, aluminum alloy, chromium and molybdenum.

The first to n^{th} gate lines GL1 to GLn, the first to n^{th} data lines DL1 to DLm, and a pixel unit 120 serve as a basic unit of displaying the image formed in each pixel area. In one exemplary embodiment, the first to n^{th} gate lines GL1 to GLn and the first to n^{th} data lines DL1 to DLm define the pixel areas. The pixel unit 120 includes a thin film transistor (“TFT”) 121 formed on the base substrate 110 and a pixel electrode 122 electrically connected with the TFT 121. The TFT 121 is electrically connected with a corresponding gate line of the first to n^{th} gate lines GL1 to GLn, and is electrically connected with a corresponding data line of the first to m^{th} data lines DL1 to DLm to switch a pixel voltage corresponding to the image. The pixel electrode 122 outputs the pixel voltage, and includes transparent conductive material such as indium tin oxide (“ITO”) or indium zinc oxide (“IZO”).

The array substrate 100 further includes the gate insulating layer 130, a protective film 140 and an organic insulating layer 150 to protect interconnection layers formed on the first base substrate 110. The gate insulating layer 130 is formed on the first base substrate 110 to cover the first to n^{th} gate lines GL1 to GLn. The first to m^{th} data lines DL1 to DLm are formed on an upper surface of the gate insulating layer 130, and the protective layer 140 is formed on the gate insulating layer 130 to cover the first to m^{th} data lines DL1 to DLm. The organic insulating layer 150 is formed on an upper surface of the protective layer 140 to planarize the array substrate 100, and the pixel electrode 122 is formed on an upper surface of the organic insulating layer 150. The protective layer 140 and the organic insulating layer 150 are removed from an upper portion of the data pad section DL_Pa to form a via hole VH.

A pad electrode PE is formed on the upper surface of the organic insulating layer 150, within the via hole VH, and on the data pad section DL_Pa to electrically connect the data driver 400 with the data pad section DL_Pa. The pad electrode PE is electrically connected with the data pad section DL_Pa through the via hole VH, and includes the transparent conductive material such as ITO or IZO.

The opposite substrate 200 is provided on the array substrate 100. The opposite substrate 200 includes a second base substrate 210, a color filter layer 220 which is formed on the second base substrate 210 to exhibit a predetermined color, and a common electrode 230 which outputs a common voltage. The common electrode 230 faces the pixel electrode 122 while interposing the liquid crystal layer 310 therebetween, and includes the transparent conductive material such as ITO or IZO.

The liquid crystal layer 310 and the sealant 320 are interposed between the array substrate 100 and the opposite substrate 200. The liquid crystal layer 310 is formed in the display area DA to control light transmittance according to an electric field formed between the array substrate 100 and the opposite substrate 200 by the pixel electrodes 122 and the common electrode 230, and the sealant 320 couples the array substrate 100 to the opposite substrate 200 so that the liquid crystal layer 310 is sealed between the array substrate 100 and the opposite substrate 200.

The data driver 400 is provided on the data pad section DL_Pa in the peripheral area PA, and receives an image signals corresponding to the image from an outside and outputs the data signals to the data pad section DL_Pa. In the present exemplary embodiment, the data driver 400 is prepared in a drive chip that is provided at a rear surface thereof with a plurality of bumps 401 that generate data signals. In addition, the data driver 400 may be prepared in the form of a film having a plurality of wires, such as a tape carrier package (“TCP”) or a flexible circuit board.

The LCD 600 further includes a conductive bonding member 500 that is interposed between the data driver 400 and the array substrate 100 to fix the data driver 400 to the array substrate 100. The conductive bonding member 500 is provided on the pad electrode PE, and may overlap portions of the organic insulating layer 150, and includes insulating bonding material 510 and conductive particles 520. The insulating bonding material 510 is cured by light and heat, so that the data driver 400 is attached to the array substrate 100, and the conductive particles 520 are dispersed in the insulating bonding material 510 to electrically connect the data driver 400 with the pad electrode PE. As an example of the conductive bonding member 500, an anisotropic conductive film (“ACF”) may be used.

The gate driver 450 is formed in the peripheral area PA to output the gate signals to the first to n^{th} gate lines GL1 to GLn. In the present exemplary embodiment, the gate driver 450 includes a circuit module that is substantially simultaneously formed when forming the TFT 121, and the circuit module is integrally formed with the array substrate 100. However, the gate driver 450 may alternatively include a drive chip or a film having wires similar to the data driver 400. In this case, a gate pad section (not shown) having a shape the same as or substantially the same as that of the data pad DL_Pa may be formed at each end portion of the first to n^{th} gate lines GL1 to GLn to receive the gate signals from the gate driver 450, and the gate driver 450 may be attached to the array substrate 100 using the conductive bonding member 500.

Hereinafter, an exemplary method of mounting the array substrate 100 on the data driver 400 will be explained in detail with reference to the drawings.

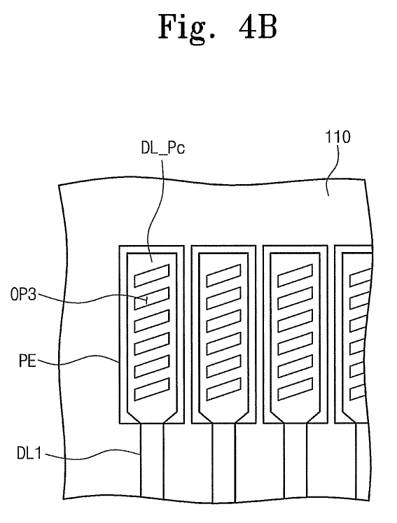

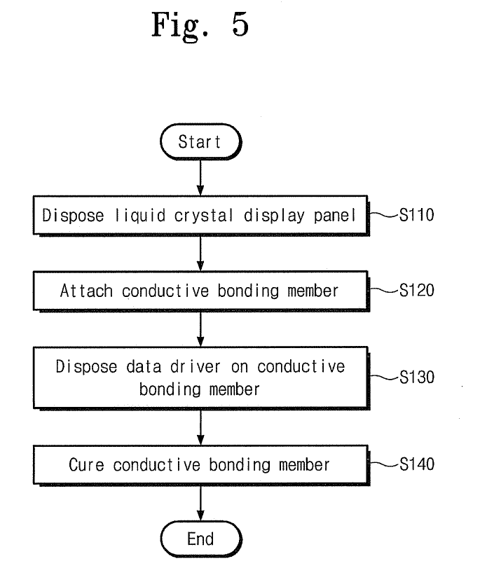

FIG. 5 is a flowchart representing an exemplary embodiment of a method of manufacturing the exemplary LCD according to the present invention, and FIG. 6 is a sectional view representing an exemplary process of curing the conductive bonding member shown in FIG. 2.

Referring to FIGS. 5 and 6, the LCD panel LP1 is disposed on a work stage (not shown) (S110), and the conductive bonding member 500 is attached to the pad electrode PE (S120).

The data driver 400 is disposed on an upper surface of the conductive bonding member 500 (S130), and the conductive bonding member 500 is cured, thereby fixing the data driver 400 to the array substrate 100 (S140).

In order to cure the conductive bonding member 500, a pressing head 710 is disposed above the data driver 400, and an optical curing device 720 is disposed below the array substrate 100 corresponding to the conductive bonding member 500.

The optical curing device 720 includes a body 721 in which a cavity is formed, a light-feeding unit 722 which is provided in the cavity to irradiate light L to cure the conductive bonding member 500, and a lens 723 through which the light L passes. A reflective material is coated on an inner wall of the body 721 to reflect the light L that is irradiated from the light-feeding unit 722, so that use efficiency of the light L is improved. The light-feeding unit 722 irradiates the light L and provides the light L through the cavity of the body 721, through the lens 723, and to the data pad section DL_Pa. Here, the light L which is irradiated from the light-feeding unit 722 includes one of ultraviolet ray, infrared ray and laser. A distance between the light-feeding unit 722 and the lens 722 may be controlled by moving the light-feeding unit 722 in the vertical direction, and the body 721 and the lens 723 support the first base substrate 110.

While the light L is being provided to the data pad section DL_Pa from the optical curing device 720, the pressing head 710 applies pressing force against the upper surface of the data driver 400 to attach the data driver 400 to the array substrate 100. A portion of the light L is absorbed in the material of the data pad section DL_Pa, and the remaining light is directly irradiated to the conductive bonding member 500 through the openings OP1 of the data pad section DL_Pa and through the transparent pad electrode PE. That is, the data pad section DL_Pa, except for the openings OP1, absorbs the light L to generate heat, and the heat is transmitted and spread to the conductive bonding member 500, thereby curing the conductive bonding member 500 using heat. The light passing through the opening OP1 is incident onto the conductive bonding member 500 through the pad electrode PE to further cure the conductive bonding member 500 using light.

In this manner, according to the LCD panel LP1, the opening or openings OP1 is formed in the data pad section DL_Pa, so that a portion of light passes through the opening or openings OP1 and the remaining light is absorbed in the data pad section DL_Pa to generate heat. Accordingly, the conductive bonding member 500 is cured by the light directly irradiated through the opening OP1 and the heat generated from the data pad section DL_Pa. Thus, the amount of heat needed to cure the conductive bonding member 500 is reduced, and the temperature difference between the array substrate 100 and the data driver 400 is reduced, thereby improving the yield of the products. In addition, the curing time for the conductive bonding member 500 is shortened, thereby improving productivity.

While the method of manufacturing the LCD as described with respect to FIGS. 5 and 6 includes irradiating light L through openings OP1 in the data pad section DL_Pa, it should be understood that the same method may also be employed with data pad sections DL_Pb and DL_Pc having openings OP2 and OP3, respectively, as shown in FIGS. 4A and 4B.

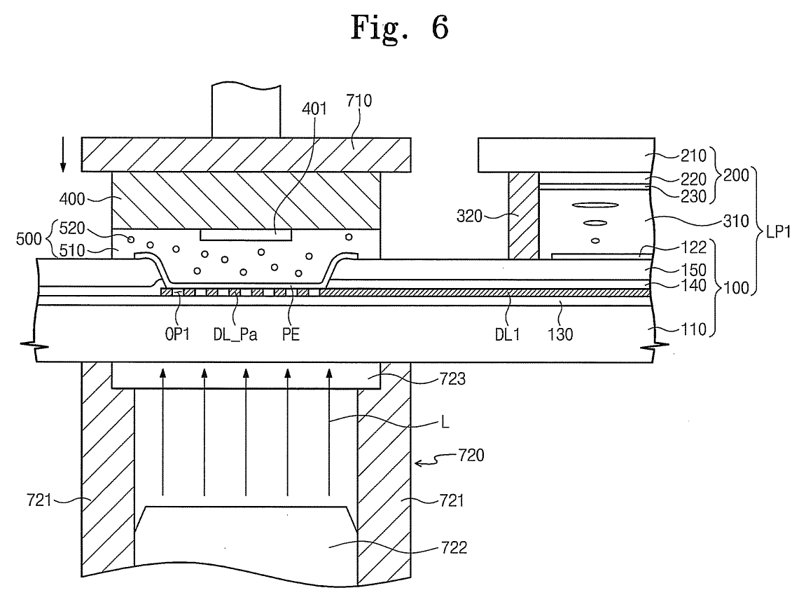

FIG. 7 is a plan view representing another exemplary embodiment of an LCD according to the present invention.

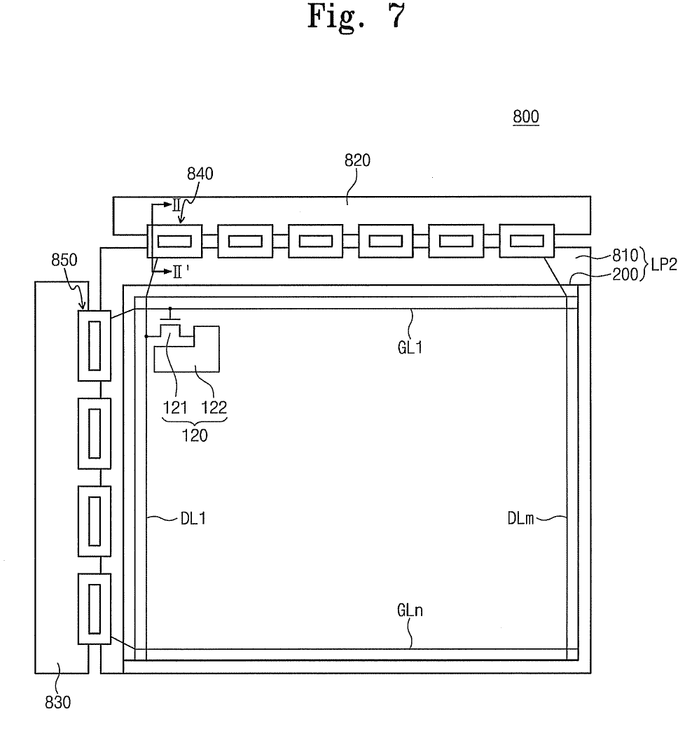

Referring to FIGS. 7 and 8, an LCD 800 includes an LCD panel LP2 which displays an image, a data printed circuit board (“PCB”) 820 which outputs data control signals corresponding to the image, a gate PCB 830 which outputs gate control signals corresponding to the image, a plurality of data TCPs 840 which output data signals in response to the data control signals and a plurality of gate TCPs 850 which output gate signals in response to the gate control signals.

The LCD panel LP2 includes an array substrate 810, an opposite substrate 200, a liquid crystal layer 310 and a sealant 320.

The array substrate 810 includes a first base substrate 110, a plurality of data lines DL1 to DLm, a plurality of gate lines GL1 to GLn, and a pixel unit 120. In FIGS. 7 and 8, since the first base substrate 110, the data lines DL1 to DLm, the gate lines GL1 to GLn, and the pixel unit 120 have structures identical to those of the first base substrate 110, the data lines DL1 to DLm, the gate lines GL1 to GLn, and the pixel unit 120 shown in FIGS. 1 and 2, the same reference numerals will be assigned to the same elements and detailed description thereof will be omitted in order to avoid redundancy.

The data lines DL1 to DLm include the first to m data line DL1 to DLm, and data pad sections DLP are formed at each end portion of the first to m^{th} data lines DL1 to DLm. The data pad sections DLP are formed in the peripheral area PA to receive the data signals from the data TCP 840.

The gate lines GL1 to GLn include the first to n gate lines GL1 to GLn, gate pad sections (not shown) are formed at each end portion of the first to n^{th} gate lines GL1 to GLn. The gate pad sections are formed in the peripheral area PA to receive the gate signals from the gate TCP 850.

The pixel unit 120 is formed in each pixel area, to output the pixel voltage. In one exemplary embodiment, the pixel areas may be defined by the first to n^{th} gate lines GL1 to GLn and the first to m^{th} data lines DL1 to DLm.

The array substrate 810 further includes a gate insulating layer 130, a protective layer 140 and an organic insulating layer 150 to protect interconnection layers formed on the first base substrate 110. The pixel electrode 122 is formed at an upper surface of the organic insulating layer 150, and the protective layer 140 and the organic insulating layer 150 are removed from an upper portion of the data pad section DLP to form a via hole VH. Although not shown in FIGS. 7 and 8, the protective layer 140 and the organic insulating layer 150 are also removed from an upper portion of the gate pad section to form a via hole VH through which the gate pad section is exposed.

A pad electrode PE is formed on the upper surface of the organic insulating layer 150 and within the via hole VH and on the data pad section DLP to electrically connect the data TCP 840 with the data pad section DLP. The data pad electrode PE is electrically connected with the data pad section DLP through the via hole VH, and includes a transparent conductive material such as ITO or the IZO. Although not shown in the drawings, the gate pad section also has a gate pad electrode formed thereon to electrically connect the gate pad section with the gate TCP 850.

The opposite substrate 200 is provided on the array substrate 810, and the liquid crystal layer 310 and the sealant 320 are interposed between the array substrate 810 and the opposite substrate 200. In the present exemplary embodiment, since the opposite substrate 200, the liquid crystal layer 310 and the sealant 320 have structures identical to those of the opposite substrate 200, the liquid crystal layer 310 and the sealant 320 of the LCD panel shown in FIGS. 1 and 2, the same reference numerals will be assigned to the same elements and detailed description thereof will be omitted in order to avoid redundancy.

The data PCB 820 is electrically connected with the data TCPs 840 to output the data control signals to each data TCP 840. The gate PCB 830 is electrically connected with the gate TCPs 850 to output the gate control signals to each gate TCP 850.

The data TCP 840 is attached to the array substrate 810, and is electrically connected with the data pad sections DLP to output the data signals to the data pad sections DLP. The gate TCP 850 is attached to the array substrate 810, and is electrically connected with the gate pad section to output the gate signals to the gate pad section. According to the present exemplary embodiment, the data TCP 840 has a structure that may be substantially identical to that of the gate TCP 850. Accordingly, the data TCP 840 will be described below as a representative example.

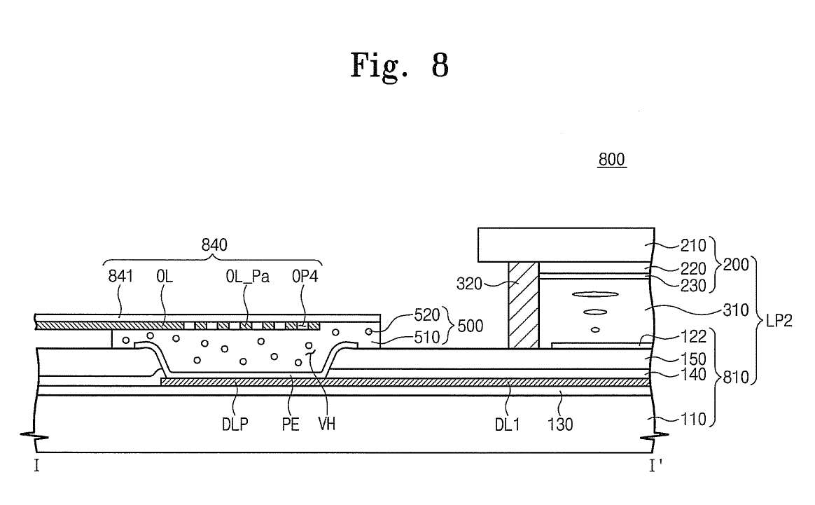

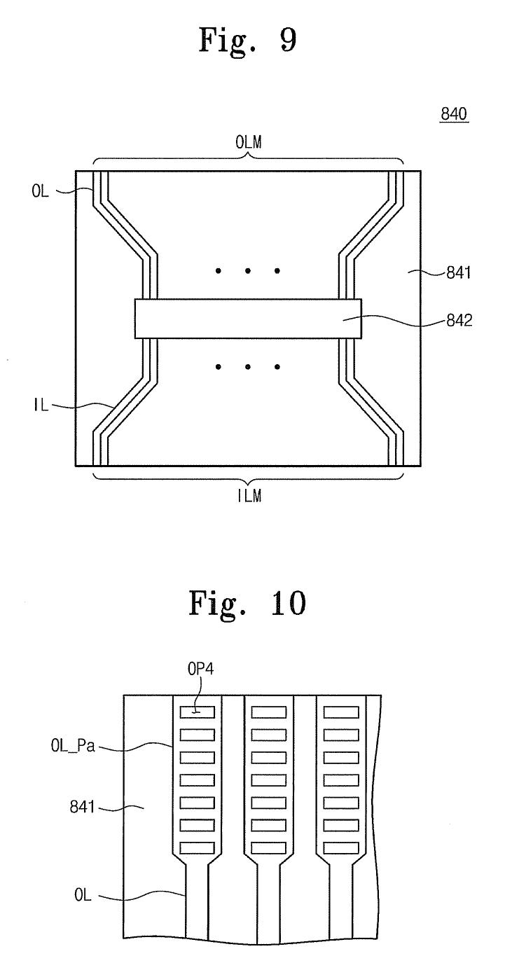

FIG. 9 is a plan view representing the exemplary data TCP shown in FIG. 7, and FIG. 10 is a plan view representing an exemplary output lead line shown in FIG. 9.

Referring to FIGS. 9 and 10, the data TCP 840 includes a base film 841, a drive chip 842 that is mounted on the base film 841, an input lead module ILM transmitting the data control signals from the data PCB 820 and an output lead module OLM transmitting the data signals to the array substrate 810. The input lead module ILM includes a plurality of input lead lines IL, and receives the data control signals to output the data control signals to the drive chip 842. The drive chip 842 outputs the data signals to the output lead module OLM in response to the data control signals.

The output lead module OLM includes a plurality of output lead lines OL. A lead pad section OL_Pa is formed at one end portion of each output lead line OL to output the data signals from the drive chip 842 to the data pad section DLP (see, FIG. 8). The lead pad section OL_Pa extends from the end portion of the output lead line OL, and has a width larger than that of the output lead line OL. A portion of the lead pad section OL_Pa is removed to form a plurality of openings OP4 having a slit structure.

As an example of the present invention, the openings OP4 are arranged with respect to each other in a longitudinal direction of the lead pad section OL_Pa, and each opening OP4 extends in a width direction of the lead pad section OL_Pa. When the openings OP4 are viewed in a plan view, the openings OP4 are arranged substantially in parallel with respect to each other in the longitudinal direction of the lead pad section OL_Pa. However, in an alternative exemplary embodiment, the opening OP4 may extend in the longitudinal direction of the lead pad section OL_Pa, and the openings OP4 may be arranged with respect to each other in the width direction of the lead pad section OL_Pa.

In the present exemplary embodiment, although the lead pad section OL_Pa is illustrated as being provided with 7 openings formed therethrough, the number of the openings may be changed according to the width, the material and the process condition of the lead pad section OL_Pa.

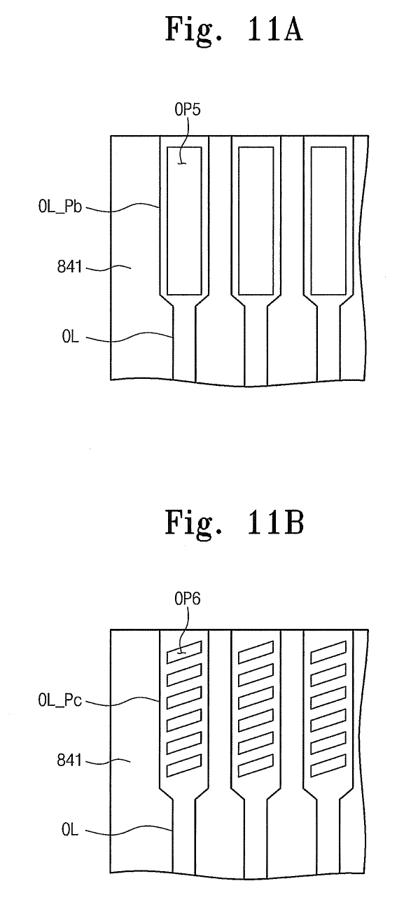

FIGS. 11A and 11B are plan views representing other exemplary embodiments of the lead pad section shown in FIG. 10.

Referring to FIG. 11A, the middle portion of the lead pad section OL_Pb is removed to form a single opening OP5. The opening OP5 extends in the longitudinal direction of the lead pad section OL_Pb.

Referring to FIG. 11B, a portion of the lead pad section OL_Pc is removed to form a plurality of openings OP6 having a slit structure. The openings OP6 are arranged with respect to each other in the longitudinal direction of the lead pad section OL_Pc, and each opening OP6 extends substantially in the width direction of the lead pad section OL_Pc. When the opening OP6 is viewed in a plan view, the opening OP6 is inclined with respect to the longitudinal direction of the lead pad section OL_Pc.

Referring to FIGS. 7 and 8 again, the LCD 800 further includes a conductive bonding member 500 that is interposed between the data TCP 840 and the array substrate 810 to fix the data TCP 840 to the array substrate 810. Since the conductive bonding member 500 has a structure identical to that of the conductive bonding member 500 shown in FIG. 2, the same reference numerals will be assigned to the same elements, and detailed description thereof will be omitted in order to avoid redundancy. Although not shown in the drawings, the array substrate 810 has the gate TCP 850 attached thereto using the conductive bonding member 500, similar to the data TCP 840.

Hereinafter, an exemplary process of attaching the data TCP 840 to the LCD panel LP2 will be explained in detail with reference to the drawings.

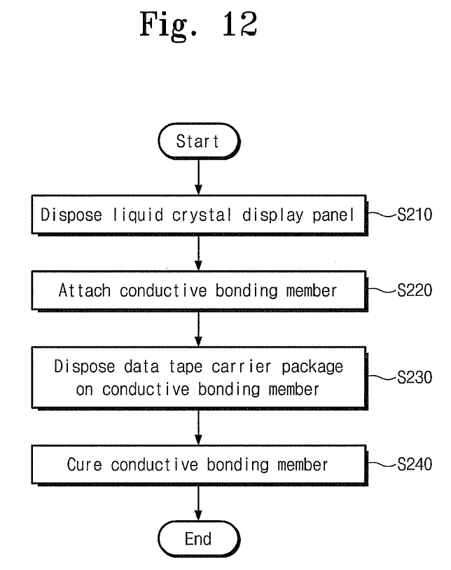

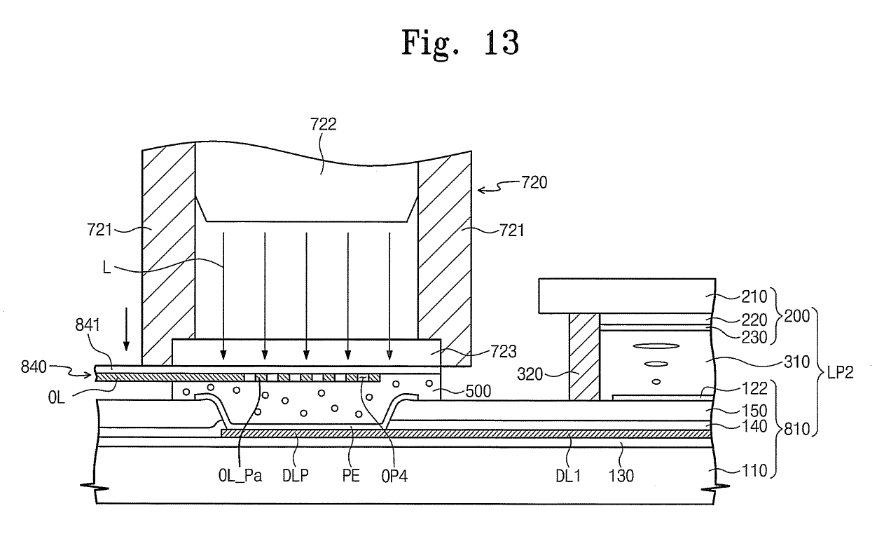

FIG. 12 is a flowchart representing another exemplary embodiment of a method of fabricating the exemplary LCD according to the present invention, and FIG. 13 is a sectional view representing an exemplary process of curing the exemplary conductive bonding member shown in FIG. 7.

Referring to FIGS. 12 and 13, the LCD panel LP2 is disposed on a work stage (not shown) (S210), and the conductive bonding member 500 is attached to the pad electrode PE (S220).

After the data TCP 840 is disposed on an upper surface of the conductive bonding member 500 (S230), the conductive bonding member 500 is cured, so that the data TCP 840 is fixed to the array substrate 810 (S240).

In order to cure the conductive bonding member 500, an optical curing device 720 is disposed above the array substrate 810 and on the data TCP 840 corresponding to the conductive bonding member 500. Since the optical curing device 720 has a structure identical to that of the optical curing device 720 shown in FIG. 6, the same reference numerals will be assigned to the same elements and detailed description thereof will be omitted in order to avoid redundancy.

The optical curing device 720 presses the upper surface of the data TCP 840 to attach the data TCP 840 to the array substrate 810, and at the same time, irradiates light L to cure the conductive bonding member 500. A portion of light L is absorbed in the material of the lead pad section OL_Pa, and the remaining light L is directly incident onto the conductive bonding member 500 through the openings OP4.

That is, the lead pad section OL_Pa, except for the openings OP4, absorbs the light L to generate heat, and the heat is transmitted and spread to the conductive bonding member 500, thereby curing the conductive bonding member 500 with heat. The light passing through the openings OP4 is incident onto the conductive bonding member 500 to cure the conductive bonding member 500 with light.

As described above, in the data TCP 840, the openings OP4 are formed in the lead pad section OL_Pa, so that a portion of light L passes through the openings OP4 and the remaining light L is absorbed in the lead pad section OL_Pa to generate heat. Accordingly, the conductive bonding member 500 is cured by the light L directly irradiated onto the conductive bonding member 500, and the heat generated from the lead pad section OL_Pa. Thus, the amount of heat needed to cure the conductive bonding member 500 is reduced, and the temperature difference between the array substrate 810 and the data TCP 840 is reduced, so that the yield of the products is improved. In addition, the curing time for the conductive bonding member 500 is reduced, thereby improving the productivity.

Although the process of attaching the data TCP 840 to the array substrate 810 has been described above, it should be noted that the gate TCP 850 may also be attached to the array substrate 810 through the same process for the data TCP 840.

Also, while the method of manufacturing the LCD as described with respect to FIGS. 12 and 13 includes irradiating light L through openings OP4 in the lead pad section OL_Pa, it should be understood that the same method may also be employed with data pad sections OL_Pb and OL_Pc having openings OP5 and OP6, respectively, as shown in FIGS. 11A and 11B.

According to the above, the opening is formed in the data pad section to allow light to pass therethrough, and the conductive bonding member is cured by the light provided from below the data pad section and by the heat of the data pad section. Accordingly, the amount of heat needed to cure the conductive bonding member is reduced, and the temperature difference between the array substrate and the data driver is reduced, so that the array substrate is prevented from being bent, thereby improving the yield of products. In addition, the curing time for the conductive bonding member is reduced, thereby improving the productivity.

In addition, the opening is formed in the lead pad section of the data TCP to allow the light to pass therethrough, and the conductive bonding member is cured by the light provided from above the data TCP and by the heat of the lead pad section. Thus, the heat needed to cure the conductive bonding member is reduced, thereby reducing the temperature difference between the array substrate and the data TCP. Therefore, the array substrate is prevented from being bent, and the yield of the products is improved.

Although the exemplary embodiments of the present invention have been described, it is understood that the present invention should not be limited to these exemplary embodiments but various changes and modifications can be made by one of ordinary skill in the art within the spirit and scope of the present invention as hereinafter claimed.

What is claimed is:

1. A display apparatus comprising:
a display panel which comprises at least one signal line transmitting image signals and a signal pad section which extends from an end portion of each of the at least one signal line to receive the image signals and a portion of which is removed to form at least one opening, to display images corresponding to the image signals received through the signal pad section and the signal lines;
a driver mounted on the display panel to output the image signals to the signal pad section; and
a conductive bonding member interposed between the driver and the signal pad section to attach the driver to the display panel and to electrically connect the signal pad section with the driver.

2. The display apparatus of claim 1, wherein the conductive bonding member is cured by a light provided from below the driver, the display panel interposed between the driver and the light.

3. The display apparatus of claim 2, wherein the light comprises one of laser, ultra-violet, and infrared rays.

4. The display apparatus of claim 2, further comprising a transparent pad electrode formed on the signal pad section, wherein the conductive bonding member is cured by the light passing through the at least one opening in the signal pad section and through the transparent pad electrode.

5. The display apparatus of claim 2, wherein the conductive bonding member comprises an anisotropic conductive film.

6. The display apparatus of claim 1, wherein the at least one opening includes one opening formed in a middle portion of the signal pad section.

7. The display apparatus of claim 1, wherein the at least one opening includes a plurality of openings formed in the signal pad section, and the openings each have a slit shape.

8. The display apparatus of claim 1, wherein the display panel further comprises a pad electrode which is interposed between the signal pad section and the conductive bonding member to electrically connect the signal pad section with the conductive bonding member.

9. The display apparatus of claim 1, wherein the driver comprises a semiconductor chip.

10. The display apparatus of claim 1, wherein the driver comprises:
a base film; and
an interconnection formed on the base film to output the image signal to the signal pad section.

11. A display apparatus comprising:
a display panel that displays an image in response to image signals;
a driver comprising a base film, at least one lead line which is formed at an upper surface of the base film to transmit the image signals, and a lead pad section which extends from an end portion of each of the at least one lead line to output the image signals that is received through the at least one lead line to the display panel and a portion of which is removed to form at least one opening; and
a conductive bonding member that is interposed between the lead pad section and the display panel to attach the driver to the display panel and to electrically connect the lead pad section with the display panel.

12. The display apparatus of claim 11, wherein the conductive bonding member is cured by a light provided from above the base film, the base film interposed between the light and the display panel.

13. The display apparatus of claim 12, wherein the light comprises one of laser, ultra-violet, and infrared rays.

14. The display apparatus of claim 11, wherein the at least one opening includes one opening formed in a middle portion of the lead pad section.

15. The display apparatus of claim 11, wherein the at least one opening includes a plurality of openings formed in the lead pad section, and the openings have a slit shape.

16. The display apparatus of claim 11, wherein the display panel comprises:
at least one signal line which transmits the image signals; and
a signal pad section which extends from an end portion of each of the at least one signal line and is electrically connected with the lead pad section through the conductive bonding member to receive the image signals from the lead pad section.

17. A method of manufacturing a display apparatus, the method comprising:
disposing a display panel having a signal pad section formed with at least one opening and which receives image signals;
attaching a conductive bonding member to an upper portion of the signal pad section;
disposing a driver, which outputs the image signals, on an upper surface of the conductive bonding member; and
irradiating a light onto the signal pad section from below the display panel while pressing the driver against the display panel to cure the conductive bonding member.

18. The method of claim 17, wherein curing of the conductive bonding member comprises:
disposing an optical curing device below the display panel corresponding to the conductive bonding member;
disposing a pressing head on the driver; and
allowing the light irradiated from the optical curing device to be incident onto the signal pad section while pressing the driver against the display panel by moving the pressing head downward.

19. The method of claim 17, wherein the light is absorbed in the signal pad section to generate a heat, and is incident into the conductive bonding member through the opening.

20. The method of claim 17, further comprising disposing a transparent pad electrode on the signal pad section prior to attaching a conductive bonding member to an upper portion of the signal pad section, wherein the light irradiates through the at least one opening of the signal pad section and through the transparent pad electrode to cure the conductive bonding member.

21. A method of manufacturing a display apparatus, the method comprising:
disposing a display panel having a signal pad section that receives image signals and transmits the image signals to a signal line;
attaching a conductive bonding member to an upper portion of the signal pad section;
disposing a driver having a lead pad section, which is formed with at least one opening and outputs the image signals, on an upper surface of the conductive bonding member; and
curing the conductive bonding member by irradiating a light onto the lead pad section from above the driver while pressing the driver against the display panel.

22. The method of claim 21, wherein curing the conductive bonding member comprises:
disposing an optical curing device above the driver corresponding to the conductive bonding member; and
allowing the light irradiated from the optical curing device to be incident onto the lead pad section while pressing the driver by moving the optical curing device downward.

23. The method of claim 21, wherein the light is absorbed in the lead pad section to generate a heat, and is incident onto the conductive bonding member through the at least one opening.
